(19) United States
(12) Patent Application Publication
(10) Pub. No.: US 2025/0206028 A1
(43) Pub. Date: Jun. 26, 2025

(54) LIQUID EJECTING DEVICE

(71) Applicant: SEIKO EPSON CORPORATION, Tokyo (JP)

(72) Inventor: Hiroyuki NAKAYAMA, SHIOJIRI-SHI (JP)

(21) Appl. No.: 18/990,394

(22) Filed: Dec. 20, 2024

(30) Foreign Application Priority Data
Dec. 22, 2023 (JP) 2023-217145

(51) Int. Cl. B41J 2/175

(52) U.S. Cl. CPC B41J 2/17553; B41J 2/17509; B41J 2/17523

(57) ABSTRACT

A liquid ejecting device that includes a liquid ejecting unit configured to eject liquid, a main body on which the liquid ejecting unit is mounted, a liquid supply device configured to be movable independently of the main body, a main body side engaging portion configured to engage with the liquid supply device, and a liquid supply device side engaging portion configured to engage with the main body, wherein the main body side engaging portion includes a lower receiving portion that receives the liquid supply device side engaging portion from below in a vertical direction, and the liquid supply device side engaging portion includes an upper receiving portion that engages with the lower receiving portion, and is received by the main body side engaging portion from below in the vertical direction by the upper receiving portion engaging with and received by the lower receiving portion.

The present application is based on, and claims priority from JP Application Serial Number 2023-217145, filed Dec. 22, 2023, the disclosure of which is hereby incorporated by reference herein in its entirety.

### BACKGROUND

### 1. Technical Field

The present disclosure relates to a liquid ejecting device.

### 2. Related Art

In the past, various types of liquid ejecting devices have been used. Among them, there is a liquid ejecting device configured such that a main body that ejects liquid and a liquid supply device that supplies the liquid to the main body are movable. For example, JP 2020-199700 A discloses a printer system including a printer that performs printing by ejecting ink, and a liquid supply device that supplies the ink to the printer, in which the printer and the liquid supply device are coupled via a plurality of tubes and are configured to be movable.

In an existing liquid ejecting device in which a main body and a liquid supply device are configured to be movable as in the printer system of JP 2020-199700 A, for example, when the liquid ejecting device is moved, or the like, there was a risk that the main body and the liquid supply device are so far away from each other that a liquid supply path such as a tube is damaged, or there was a risk that the main body and the liquid supply device are too close to each other to collide with each other. Here, the positional relationship between the main body and the liquid supply device includes a positional relationship in a vertical direction in addition to a positional relationship in a horizontal direction.

### SUMMARY

A liquid ejecting device according to the present disclosure for solving the above-described problems includes a liquid ejecting unit configured to eject liquid, a main body on which the liquid ejecting unit is mounted, a liquid supply device configured to be movable independently of the main body and configured to supply the liquid to the liquid ejecting unit via a liquid supply path, a main body side engaging portion provided at the main body and configured to engage with the liquid supply device, and a liquid supply device side engaging portion provided at the liquid supply device and configured to engage with the main body, wherein the main body side engaging portion includes a lower receiving portion that receives the liquid supply device side engaging portion from below in a vertical direction, and the liquid supply device side engaging portion includes an upper receiving portion that engages with the lower receiving portion, and is received by the main body side engaging portion from below in the vertical direction by the upper receiving portion engaging with and received by the lower receiving portion.

### BRIEF DESCRIPTION OF THE DRAWINGS

FIG. 1 is a schematic side view of a liquid ejecting device according to Example 1 of the present disclosure.

FIG. 2 is a perspective view from a front side of the liquid ejecting device in FIG. 1.

FIG. 3 is a front view of the liquid ejecting device in FIG. 1.

FIG. 4 is a perspective view from a back side of the liquid ejecting device in FIG. 1, and is a diagram illustrating a state in which a liquid supply device and a main body are not coupled to each other by a liquid supply path at a coupling portion.

FIG. 5 is a partial perspective view from the back side of the liquid ejecting device in FIG. 1, and is a diagram illustrating a state in which the liquid supply device and the main body are coupled to each other by the liquid supply path at the coupling portion.

FIG. 6 is a perspective view of a periphery of a main body side engaging portion as an engaging portion between the main body and the liquid supply device in the liquid ejecting device in FIG. 1.

FIG. 7 is a perspective view of a periphery of a liquid supply device side engaging portion as an engaging portion between the main body and the liquid supply device in the liquid ejecting device in FIG. 1.

FIG. 8 is a front view of the engaging portions between the main body and the liquid supply device in the liquid ejecting device in FIG. 1.

FIG. 9 is a partially enlarged view of the engaging portions in FIG. 8.

FIG. 10 is a partially enlarged view of engaging portions between a main body and a liquid supply device of a liquid ejecting device according to Example 2 of the present disclosure.

FIG. 11 is a partially enlarged view of engaging portions between a main body and a liquid supply device of a liquid ejecting device according to Example 3 of the present disclosure.

### DESCRIPTION OF EMBODIMENTS

First, the present disclosure will be schematically described.

A liquid ejecting device according to a first aspect according to the present disclosure for solving the above-described problems includes a liquid ejecting unit configured to eject liquid, a main body on which the liquid ejecting unit is mounted, a liquid supply device configured to be movable independently of the main body and configured to supply the liquid to the liquid ejecting unit via a liquid supply path, a main body side engaging portion provided at the main body and configured to engage with the liquid supply device, and a liquid supply device side engaging portion provided at the liquid supply device and configured to engage with the main body, wherein the main body side engaging portion includes a lower receiving portion that receives the liquid supply device side engaging portion from below in a vertical direction, and the liquid supply device side engaging portion includes an upper receiving portion that engages with the lower receiving portion, and is received by the main body side engaging portion from below in the vertical direction by the upper receiving portion engaging with and received by the lower receiving portion.

According to the aspect, the main body side engaging portion includes the lower receiving portion that receives the liquid supply device side engaging portion from below in the vertical direction, the liquid supply device side engaging portion includes the upper receiving portion that engages with the lower receiving portion, and is received by the main body side engaging portion from below in the vertical direction by the upper receiving portion engaging with and received by the lower receiving portion. Therefore, the liquid supply device can be positioned in a horizontal direction with respect to the main body by the lower receiving portion and the upper receiving portion.

The liquid ejecting device according to a second aspect of the present disclosure is an aspect dependent on the first aspect, wherein the upper receiving portion and the lower receiving portion extend in an intersecting direction intersecting both a facing direction in which the liquid supply device and the main body face each other in an engagement state in which the main body and the liquid supply device are engaged with each other, and a vertical direction.

According to the aspect, the upper receiving portion and the lower receiving portion extend in the intersecting direction. For this reason, it is possible to position the liquid supply device with respect to the main body in a long region in the intersecting direction, and it is possible to suppress movement of the liquid supply device with respect to the main body in a rotating direction with the vertical direction as a rotation axis.

The liquid ejecting device according to a third aspect of the present disclosure is an aspect dependent on the second aspect, wherein one of the upper receiving portion and the lower receiving portion is an inner rail extending in the intersecting direction, and another of the upper receiving portion and the lower receiving portion is an outer rail extending in the intersecting direction and covering the inner rail when viewed from the intersecting direction.

According to the aspect, one of the upper receiving portion and the lower receiving portion is the inner rail, and the other of the upper receiving portion and the lower receiving portion is the outer rail. With such a configuration, it is possible to suppress unexpected disengagement of the main body side engaging portion and the liquid supply device side engaging portion in the engagement state, and it is possible to position the liquid supply device with respect to the main body with high accuracy in the facing direction.

The liquid ejecting device according to a fourth aspect of the present disclosure is an aspect dependent on the second aspect, wherein the upper receiving portion includes an upper rail that is received by the lower receiving portion from below in the vertical direction, and the lower receiving portion includes a lower rail that is received by the upper receiving portion from above in the vertical direction.

According to the aspect, the upper receiving portion includes the upper rail that is received by the lower receiving portion from below in the vertical direction, and the lower receiving portion includes the lower rail that is received by the upper receiving portion from above in the vertical direction. With such a configuration, the upper receiving portion and the lower receiving portion extending in the intersecting direction can be easily formed.

The liquid ejecting device according to a fifth aspect of the present disclosure is an aspect dependent on any one of the second to fourth aspects, wherein the upper receiving portion and the lower receiving portion engage with each other by the main body and the liquid supply device being relatively moved along the intersecting direction.

According to the aspect, the upper receiving portion and the lower receiving portion engage with each other by the main body and the liquid supply device being relatively moved along the intersecting direction. With such a configuration, the main body and the liquid supply device can be easily brought into the engagement state.

The liquid ejecting device according to a sixth aspect of the present disclosure is an aspect dependent on any one of the second to fourth aspects, wherein the lower receiving portion includes an upward protruding portion extending in the intersecting direction and protruding upward in the vertical direction toward the upper receiving portion, the upper receiving portion includes a downward protruding portion extending in the intersecting direction and protruding downward in the vertical direction toward the lower receiving portion, and a length in the vertical direction from the upward protruding portion to the upper receiving portion and a length in the vertical direction from the downward protruding portion to the lower receiving portion are the same.

According to the aspect, the length in the vertical direction from the upward protruding portion to the upper receiving portion and the length in the vertical direction from the downward protruding portion to the lower receiving portion are the same. With such a configuration, when the liquid supply device moves in the vertical direction with respect to the main body in the engagement state, it is possible to disperse impact force when the upper receiving portion and the lower receiving portion collide with each other. Therefore, it is possible to suppress damage to the upper receiving portion and the lower receiving portion.

The liquid ejecting device according to a seventh aspect of the present disclosure is an aspect dependent on the first aspect, wherein a coupling portion between the main body and the liquid supply device is configured to be permitted to be brought into a usable state of being coupled by the liquid supply path in an engagement state in which the main body and the liquid supply device are engaged with each other, and a relative movable range of the main body and the liquid supply device at the coupling portion is wider than a relative movable range of the main body side engaging portion and the liquid supply device side engaging portion in the usable state.

According to the aspect, in the usable state, the relative movable range of the main body and the liquid supply device at the coupling portion is wider than the relative movable range of the main body side engaging portion and the liquid supply device side engaging portion. That is, play between the main body and the liquid supply device at the coupling portion of the liquid supply path is larger than play between the main body side engaging portion and the liquid supply device side engaging portion. Therefore, even when the main body and the liquid supply device move relatively at a maximum, it is possible to prevent the liquid supply path from being detached from the main body or the liquid supply device at the coupling portion, and to prevent the coupling portion from being damaged.

The liquid ejecting device according to an eighth aspect of the present disclosure is an aspect dependent on the first aspect, wherein the main body side engaging portion and the liquid supply device side engaging portion have strength so as not to break even when the liquid supply device is brought into a state of being separated from an installation surface in an engagement state in which the main body and the liquid supply device are engaged with each other.

According to the aspect, the main body side engaging portion and the liquid supply device side engaging portion have strength so as not to break even when the liquid supply device is brought into the state of being separated from the installation surface in the engagement state. Therefore, for example, even when the liquid supply device is brought into a state of hanging down from the main body in a case where the liquid ejecting device is moved, or the like, it is possible to prevent the main body and the liquid supply device from being damaged due to damage to the main body side engaging portion and the liquid supply device side engaging portion.

### Example 1

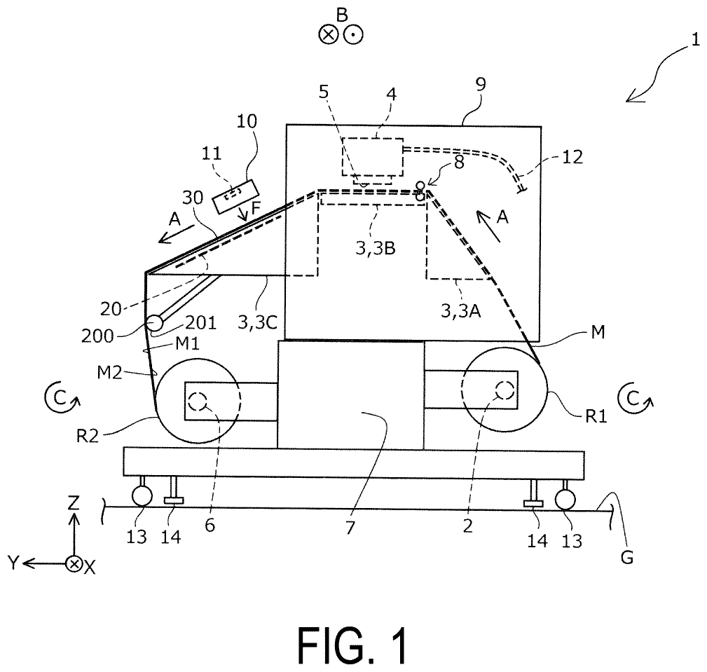

Below, embodiments according to the present disclosure will be specifically described with reference to the drawings. First, an overview of a liquid ejecting device 1 according to Example 1 of the present disclosure will be given with reference to FIG. 1. Referring to FIG. 1, some constituent members are simplified and omitted for easy understanding of the configuration. Here, in FIG. 1, an X-axis direction in the drawing is a horizontal direction and a direction in which s support portion of a supply unit 2 that holds a roll body R1 obtained by winding a medium M into a roll shape, a Y-axis direction is a horizontal direction, a front-and-rear direction of the liquid ejecting device 1, and a direction orthogonal to the X-axis direction, and a Z-axis direction is a vertical direction. Further, hereinafter, it is assumed that an arrow direction is a +direction, and a direction opposite to the arrow direction is a −direction. For example, in FIG. 1, it is assumed that a vertically upward direction is a +Z direction, a vertically downward direction is a −Z direction, a forward direction of the liquid ejecting device 1 is a +Y direction, and a rearward direction of the liquid ejecting device 1 is a −Y direction.

As illustrated in FIG. 1, the liquid ejecting device 1 according to the example includes a main body 9, and leg frames 7 are attached to portions near both ends of the main body 9 in the X-axis direction. Note that the main body 9 can also be regarded as including the supply unit 2, the leg frame 7, a medium support portion 3, a winding unit 6, and the like, which will be described later. Casters 13 and adjusters 14 are provided below the leg frames 7, the liquid ejecting device 1 can be easily moved using the casters 13, and the liquid ejecting device 1 can be suitably installed at an installation surface G by adjusting heights of a plurality of locations using the adjusters 14. Further, the liquid ejecting device 1 according to the example includes the supply unit 2 that holds the roll body R1 on the −Y direction side, which corresponds to a rear side of the main body 9. The supply unit 2 supports a paper tube of the roll body R1 around which the medium M is wound so as to sandwich the paper tube in the X-axis direction, and supplies the medium M to a position facing a head 5 as a liquid ejecting unit.

Then, in the liquid ejecting device 1 according to the example, when the medium M is transported in a transport direction A, the supply unit 2 rotates the roll body R1 in a rotating direction C. Referring to FIG. 1, the roll body R1 wound so that an image forming surface M1 on which an image is formed is on an outer side is used, but when the roll body R1 wound so that the image forming surface M1 is on an inner side is used, the supply unit 2 can rotate the roll body R1 in a direction opposite to the rotating direction C to feed the medium M.

Further, the liquid ejecting device 1 according to the example includes a transport path of the medium M including the medium support portion 3 that supports the medium M at a support face 30. The liquid ejecting device 1 according to the example includes, as the medium support portion 3, an upstream medium support portion 3A, a medium support portion 3B, and a downstream medium support portion 3C from upstream to downstream in the transport direction A. Further, the liquid ejecting device 1 further includes a roller pair 8 including a driving roller and a driven roller as a transport unit for transporting the medium M in the transport direction A on the transport path. However, the configuration of the transport unit is not specifically limited.

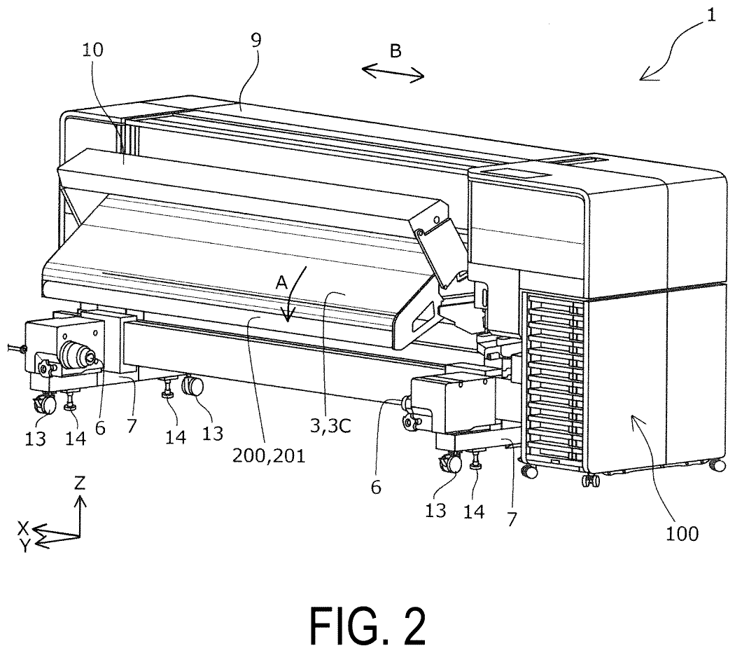

Further, the liquid ejecting device 1 according to the example includes the head 5 and a carriage 4 at a position facing the medium support portion 3B. The head 5 is a liquid ejecting unit that is provided with a plurality of nozzles and forms an image by ejecting ink being liquid from the nozzles. The carriage 4 is mounted with the head 5 and is reciprocally movable in a width direction B. A liquid supply path 12 formed of a tube or the like is coupled to the head 5, and the ink is supplied to the head 5 via the liquid supply path 12 from an ink cartridge attached to a liquid supply device 100 illustrated in FIG. 2 or the like, which will be described in detail later. In the liquid ejecting device 1 according to the example, the transport direction A at a position facing the head 5 at the medium support portion 3B is the +Y direction, the width direction B, which is a moving direction of the head 5, is a direction along the X-axis direction, and an ejecting direction of the ink is the −Z direction.

With the configuration described above, the head 5 can form an image by ejecting the ink from the nozzles (not illustrated) onto the transported medium, while reciprocating in the width direction B as a direction intersecting the transport direction A. The liquid ejecting device 1 according to the example can form a desired image on the medium M by repeating transport of the medium M by a predetermined transport amount in the transport direction A and ejection of the ink in a state in which the medium M is stopped while the head 5 moves in the width direction B.

Further, the downstream medium support portion 3C of the medium support portion 3 is provided with a heater 20 as a heating unit for heating a supported face M2 opposite to the image forming surface M1 of the medium M. The heater 20 according to the example is constituted by an electric heating wire and the like but is not limited to such a configuration. Further, not only the downstream medium support portion 3C but also the upstream medium support portion 3A or the medium support portion 3B may be provided with a medium heating unit that heats the supported face M2 opposite to the image forming surface M1 of the medium M.

Furthermore, an air blowing unit 10 that dries the ink ejected from the head 5 to the image forming surface M1 of the medium M by blowing an airflow F is provided at a portion facing the downstream medium support portion 3C in the transport path. The air blowing unit 10 according to the example includes a fan 11 that generates the airflow F and is configured to be able to blow a gas as the airflow F to the image forming surface M1 of the medium M, but is not limited to such a configuration.

Further, the winding unit 6 is provided downstream of the downstream medium support portion 3C in the transport direction A. The winding unit 6 winds the medium M transported in the transport direction A into a roll shape to obtain a roll body R2. Note that in the liquid ejecting device 1 according to the example, the supply unit 2 and the winding unit 6 have the same configuration. The medium M transported from the supply unit 2 to the winding unit 6 is transported in a state in which a predetermined tension is applied by the winding unit 6 or the like. The winding unit 6 supports a paper tube that is a winding core of the roll body R2 so as to sandwich the paper tube in the X-axis direction, and winds the medium M in a roll shape by rotating the paper tube. Referring to FIG. 1, when the winding unit 6 rotates the roll body R2 in the rotating direction C, winding is performed so that the image forming surface M1 faces outward. However, the medium M may be wound so that the image forming surface M1 faces inward. In such a case, the winding unit 6 rotates the roll body R2 in the direction opposite to the rotating direction C.

Note that a guide bar 200 is provided between the downstream medium support portion 3C and the winding unit 6 in the transport direction A. The guide bar 200 includes a contact surface 201 having an arc shape when viewed from the width direction B. Then, the guide bar 200 guides the transport of the medium M when the contact surface 201 comes into contact with the supported face M2 of the medium M wound by the winding unit 6. However, the configuration of the guide bar 200 is not particularly limited, and further, a configuration may be adopted that does not include the guide bar 200.

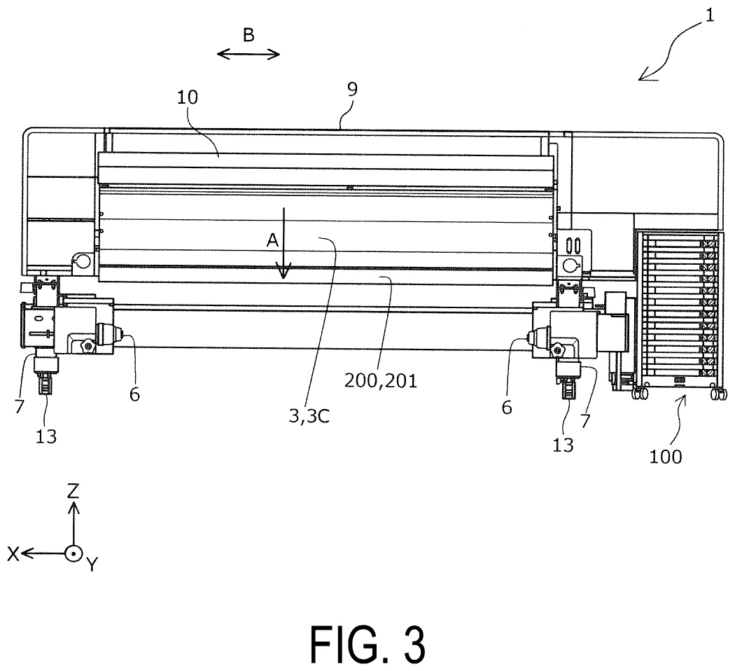

As described above, the liquid ejecting device 1 according to the example includes the head 5 that ejects ink, and the head 5 is mounted at the main body 9. Then, the liquid ejecting device 1 according to the example includes the liquid supply device 100 that supplies the ink to the head 5. Hereinafter, details of the liquid supply device 100 and an engaging portion 110 between the main body 9 and the liquid supply device 100 will be described mainly with reference to FIGS. 2 to 9.

As illustrated in FIGS. 2 to 5, and the like, the liquid supply device 100 according to the example is configured to be movable independently of the main body 9, and is configured to be capable of supplying ink to the head 5 via the liquid supply path 12. In the liquid supply device 100, a plurality of ink cartridges into which ink is injected can be mounted, and the plurality of ink cartridges can be coupled to a plurality of the liquid supply paths 12 provided corresponding to the respective ink cartridges. Then, in the liquid ejecting device 1 according to the example, the ink of each of the plurality of ink cartridges can be ejected from the head 5 onto the image forming surface M1 of the transported medium M.

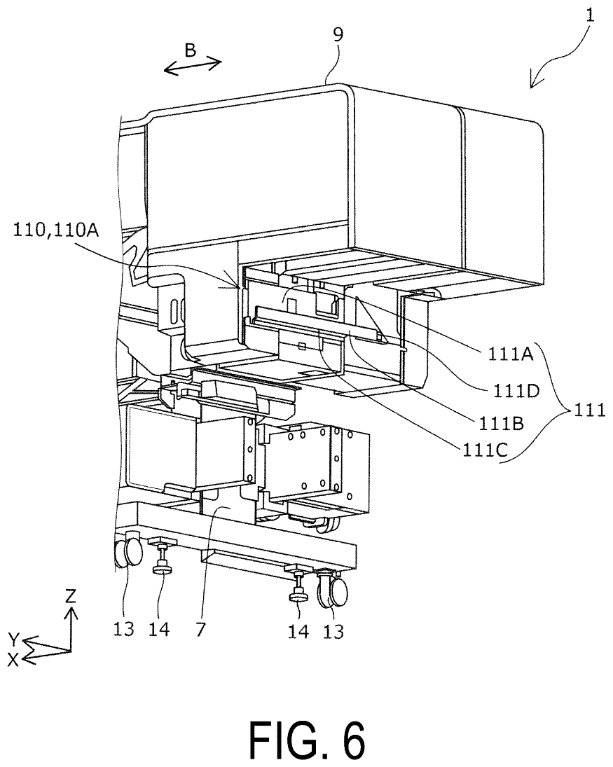

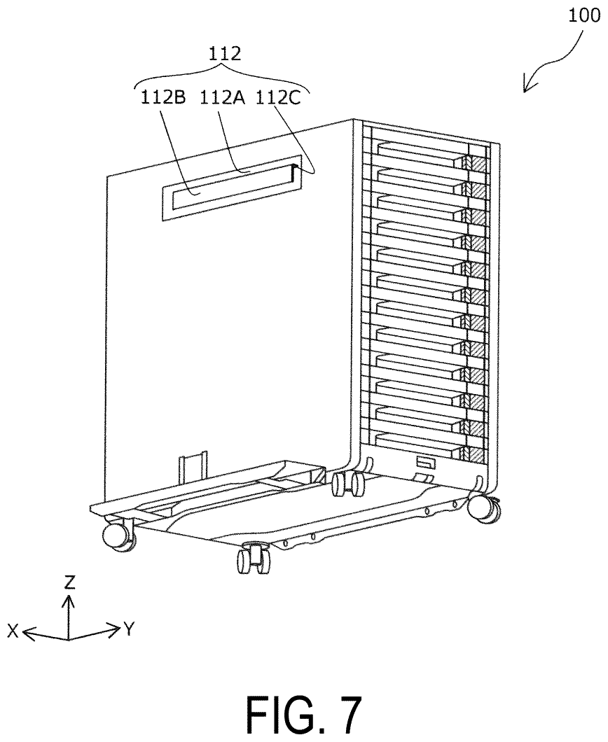

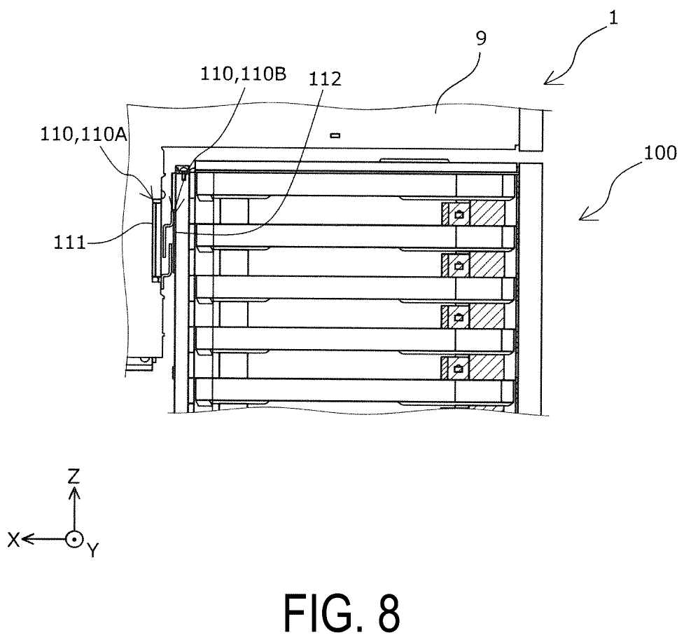

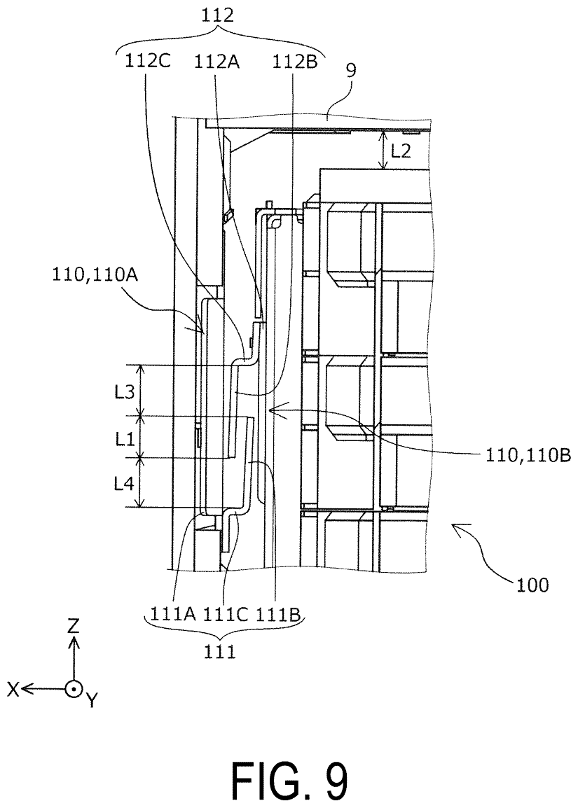

Additionally, as illustrated in FIGS. 6 to 9, the engaging portion 110 includes a main body side engaging portion 110A provided at the main body 9 and capable of engaging with the liquid supply device 100, and a liquid supply device side engaging portion 110B provided at the liquid supply device 100 and capable of engaging with the main body 9. Then, as illustrated in FIGS. 6, 8, and 9, the main body side engaging portion 110A includes a lower receiving portion 111 that receives the liquid supply device side engaging portion 110B from below in the vertical direction. Additionally, as illustrated in FIGS. 7 to 9, the liquid supply device side engaging portion 110B includes an upper receiving portion 112 that engages with the lower receiving portion 111. Then, as illustrated in FIGS. 8 and 9, the liquid supply device side engaging portion 110B is received by the main body side engaging portion 110A from below in the vertical direction by the upper receiving portion 112 engaging with and received by the lower receiving portion 111. Since the liquid supply device 100 according to the example has such a configuration, the liquid supply device 100 can be positioned in the horizontal direction with respect to the main body 9 by the lower receiving portion 111 and the upper receiving portion 112.

Here, as illustrated in FIGS. 6 and 7, the upper receiving portion 112 and the lower receiving portion 111 both extend in the Y-axis direction. In other words, in the engagement state in which the main body 9 and the liquid supply device 100 are engaged with each other as illustrated in FIGS. 2 to 5, the upper receiving portion 112 and the lower receiving portion 111 extend in the intersecting direction corresponding to the Y-axis direction intersecting both the X-axis direction, which is the facing direction in which the liquid supply device 100 and the main body 9 face each other, and the Z-axis direction corresponding to the vertical direction. For this reason, the engaging portion 110 according to the example can position the liquid supply device 100 with respect to the main body 9 in a long region in the intersecting direction, and can suppress movement of the liquid supply device 100 with respect to the main body 9 in the rotating direction with the vertical direction as a rotation axis. Furthermore, by configuring the engaging portion 110 as described above, it is possible to determine a positional relationship between the liquid supply device 100 and the main body 9 in the X-axis direction, which is the facing direction in which the liquid supply device 100 and the main body 9 face each other, with high accuracy, and, for example, as in the liquid ejecting device 1 according to the example, it is possible to obtain an external appearance as if the liquid supply device 100 and the main body 9 are integrally formed.

In addition, as illustrated in FIG. 9 and the like, the lower receiving portion 111 includes a main body attachment portion 111A and a lower rail 111B protruding in the vertically upward direction. In addition, the lower receiving portion 111 includes a plate-shaped portion 111C facing in the Z-axis direction and coupling the main body attachment portion 111A and the lower rail 111B. Then, as illustrated in FIG. 9 and the like, the upper receiving portion 112 includes a liquid supply device attachment portion 112A and an upper rail 112B protruding in the vertically downward direction. In addition, the upper receiving portion 112 includes a plate-shaped portion 112C facing in the Z-axis direction and coupling the liquid supply device attachment portion 112A and the upper rail 112B. From another point of view, the upper rail 112B can be regarded as the upper receiving portion 112 that is received by the lower receiving portion 111 from below in the vertical direction, and the lower rail 111B can be regarded as the lower receiving portion 111 that is received by the upper receiving portion 112 from above in the vertical direction. That is, the upper receiving portion 112 includes the upper rail 112B that is received by the lower receiving portion 111 from below in the vertical direction, and the lower receiving portion 111 includes the lower rail 111B that is received by the upper receiving portion 112 from above in the vertical direction. With such a configuration, the upper receiving portion 112 and the lower receiving portion 111 extending in the intersecting direction (Y-axis direction), of the engaging portion 110 according to the example, can be easily formed.

Here, in the liquid ejecting device 1 according to the example, the upper receiving portion 112 and the lower receiving portion 111 are configured to engage with each other by the main body 9 and the liquid supply device 100 being relatively moved along the intersecting direction (Y-axis direction). In other words, a configuration is adopted in which the liquid supply device 100 is moved from the +Y direction side to the −Y direction side with respect to the main body 9 to engage the upper receiving portion 112 and the lower receiving portion 111 with each other. Since the engaging portion 110 according to the example has such a configuration, the main body 9 and the liquid supply device 100 can be easily brought into the engagement state.

Note that as illustrated in FIG. 6, the lower receiving portion 111 includes a contact plate-shaped portion 111D that couples an end portion on the −Y direction side of the main body attachment portion 111A and an end portion on the −Y direction side of the lower rail 111B, and is configured to be able to come into contact with an end portion on the −Y direction side of the upper rail 112B. Therefore, when the liquid supply device 100 is moved from the +Y direction side to the −Y direction side with respect to the main body 9 to engage the upper receiving portion 112 and the lower receiving portion 111 with each other, the engaging portion 110 according to the example can prevent the liquid supply device 100 from being too close to the −Y direction side with respect to the main body 9 by the contact plate-shaped portion 111D restricting movement of the upper rail 112B to the −Y direction side.

Here, desirable lengths of the lower rail 111B and the upper rail 112B in the vertical direction will be described. As illustrated in FIG. 9, in the engagement state in which the main body 9 and the liquid supply device 100 are engaged with each other, when a length of a region where the lower rail 111B and the upper rail 112B overlap each other in the vertical direction is defined as a length L1, and an interval between the main body 9 and the liquid supply device 100 in the vertical direction is defined as a length L2, the length L1>the length L2 may hold. The liquid supply device 100 is configured to be disposed in a space below the main body 9 in the engagement state in which the main body 9 and the liquid supply device 100 are engaged with each other. A height of the main body 9 can be adjusted by the adjuster 14 or the like, and the interval between the main body 9 and the liquid supply device 100 in the vertical direction can be shortened within a range of the length L2. That is, when the main body 9 and the liquid supply device 100 come into contact with each other, the main body 9 and the liquid supply device 100 reach an approximation limit. However, when the main body 9 and the liquid supply the liquid supply device 100 are separated from each other in the vertical direction, the interval tends to be large. Therefore, a configuration is adopted in which, by providing the lower receiving portion 111 at the main body side engaging portion 110A and providing the upper receiving portion 112 at the liquid supply device side engaging portion 110B, the lower receiving portion 111 and the upper receiving portion 112 come into contact with each other before the separation between the main body 9 and the liquid supplying device 100 in the vertical direction exceeds a limit point. Since the lower receiving portion 111 and the upper receiving portion 112 come into contact with each other, even when the main body 9 moves to the +Z direction side by a predetermined amount or more, the liquid supply device 100 also moves together.

In addition, as illustrated in FIG. 9, in the engagement state in which the main body 9 and the liquid supply device 100 are engaged with each other, a shorter length of a length L3 that is an interval in the vertical direction between a tip of the lower rail 111B and the plate-shaped portion 112C and a length L4 that is an interval in the vertical direction between a tip of the upper rail 112B and the plate-shaped portion 111C, that is, play in the vertical direction between the main body 9 and the liquid supply device 100 may be equal to or greater than 5 mm. By satisfying these conditions, sufficient play is provided at the installation surface G satisfying a floor surface deflection standard of the Building Standards Act. From another point of view, the shorter length of the length L3 and the length LA may be set to a length that provides sufficient play even when the installation surface G has an inclination of 6/1000°. Note that the length L1>the length L3 and the length L4 may hold so that the main body side engaging portion 110A and the liquid supply device side engaging portion 110B are not unexpectedly disengaged in the engagement state.

In addition, in the engaging portion 110 according to the example, it can be expressed that the lower receiving portion 111 includes the lower rail 111B as an upward protruding portion that extends in the intersecting direction (Y-axis direction) and protrudes upward in the vertical direction toward the upper receiving portion 112. Then, it can be expressed that the upper receiving portion 112 includes the upper rail 112B as a downward protruding portion that extends in the intersecting direction (Y-axis direction) and protrudes downward in the vertical direction toward the lower receiving portion 111. Here, the length L3 corresponding to a length in the vertical direction from the upward protruding portion (lower rail 111B) to the plate-shaped portion 112C of the upper receiving portion 112 and the length LA corresponding to a length in the vertical direction from the downward protruding portion (upper rail 112B) to the plate-shaped portion 111C of the lower receiving portion 111 may be the same. With such a configuration, in a case where the liquid supply device 100 moves in the vertical direction with respect to the main body 9 in the engagement state, it is possible to disperse impact force when the upper receiving portion 112 and the lower receiving portion 111 collide with each other, and it is possible to suppress damage to the upper receiving portion 112 and the lower receiving portion 111. Note that “the length L3 and the length L4 are the same” means that it is sufficient that the length L3 and the length L4 are substantially the same, and a fabrication tolerance may be included.

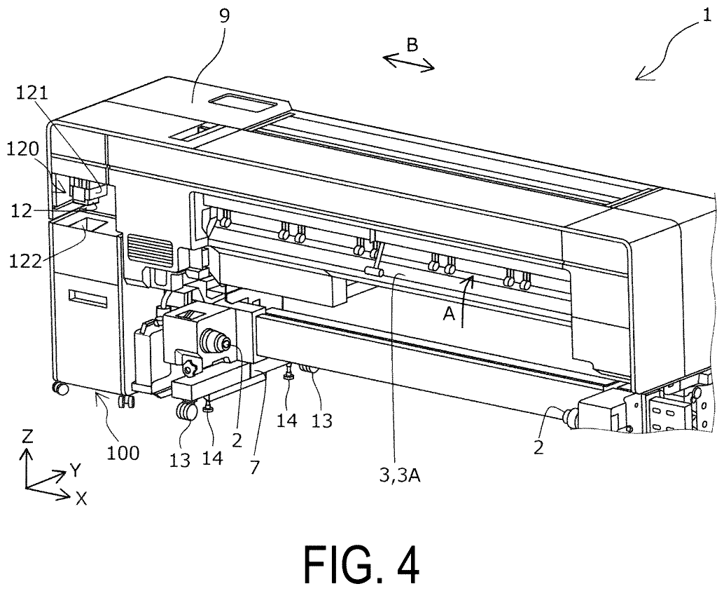

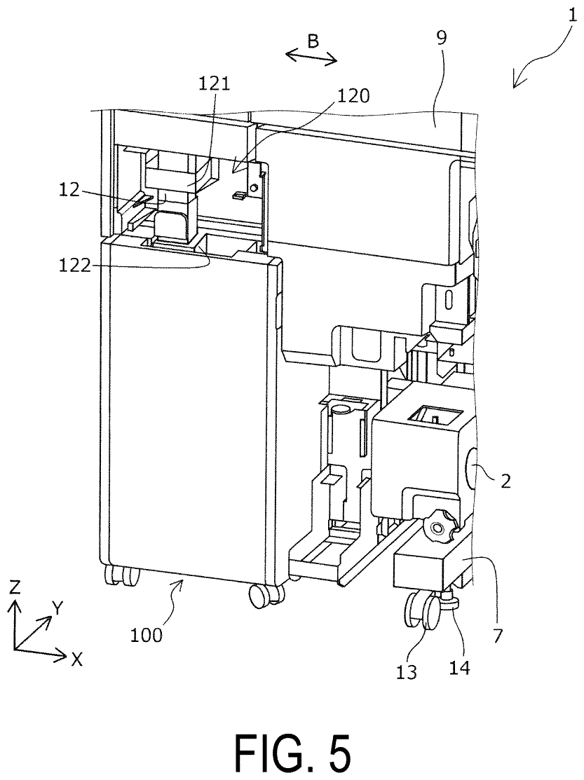

In addition, the liquid ejecting device 1 according to the example is configured to be able to bring the coupling portion 120 between the main body 9 and the liquid supply device 100 into a usable state of being coupled by the liquid supply path 12 by bringing a state illustrated in FIG. 4 into a state illustrated in FIG. 5 in the engagement state in which the main body 9 and the liquid supply device 100 are engaged with each other. Then, the liquid ejecting device 1 according to the example permits, in the usable state, relative movement between the main body 9 and the liquid supply device 100 at the coupling portion 120. That is, the coupling portion 120 is provided with play that tolerates the relative movement between the main body 9 and the liquid supply device 100.

Here, a relative movable range of the main body 9 and the liquid supply device 100 at the coupling portion 120 may be wider than a relative movable range of the main body side engaging portion 110A and the liquid supply device side engaging portion 110B. That is, the play of the main body 9 and the liquid supply device 100 at the coupling portion 120 of the liquid supply path 12 may be larger than the play of the main body side engaging portion 110A and the liquid supply device side engaging portion 110B. This is because, with such a configuration, even when the main body 9 and the liquid supply device 100 move relatively at a maximum, it is possible to prevent the liquid supply path 12 from being detached from the main body 9 or the liquid supply device 100 at the coupling portion 120, and to prevent the coupling portion 120 from being damaged.

Note that as illustrated in FIGS. 4 and 5, in the liquid ejecting device 1 according to the example, the main body 9 is provided with a main body side coupling joint portion 121, and the liquid supply device 100 is provided with a liquid supply device side coupling joint portion 122. Then, a configuration is adopted in which the liquid supply path 12 can be extended from the main body side coupling joint portion 121 toward the liquid supply device side coupling joint portion 122 for coupling.

Here, in the engaging portion 110 according to the example, the main body side engaging portion 110A and the liquid supply device side engaging portion 110B have strength so as not to break even in a state in which the liquid supply device 100 is separated from the installation surface G in the engagement state in which the main body 9 and the liquid supply device 100 are engaged with each other, for example, in a state in which the liquid supply device 100 hangs from the main body 9 at the engaging portion 110. Therefore, the liquid ejecting device 1 according to the example is configured such that, for example, even when the liquid supply device 100 is brought into a state of hanging down from the main body 9 in a case where the liquid ejecting device 1 is moved, or the like, it is possible to prevent the main body 9 and the liquid supply device 100 from being damaged due to damage to the main body side engaging portion 110A and the liquid supply device side engaging portion 110B.

### Example 2

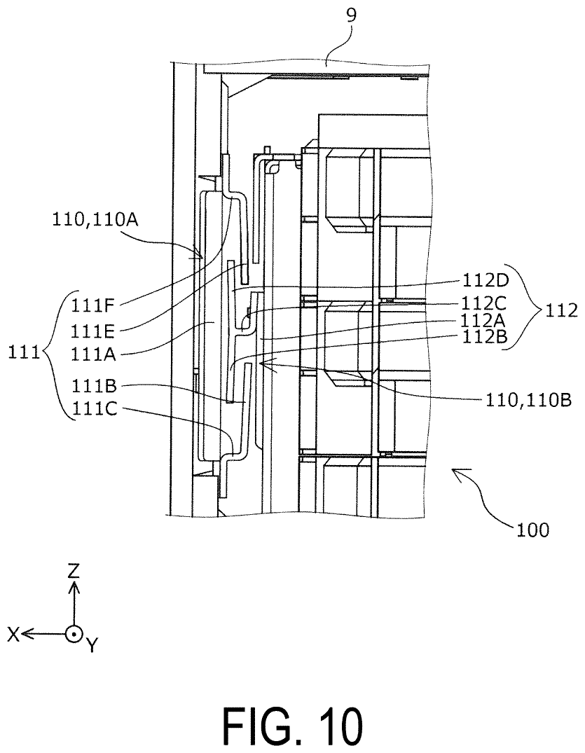

Next, the liquid ejecting device 1 according to Example 2 will be described using FIG. 10. Note that FIG. 10 is a diagram corresponding to FIG. 9 in the liquid ejecting device 1 according to Example 1. In FIG. 10, constituent members common to Example 1 described above are denoted with the same reference numerals, and detailed description thereof is omitted. Here, aside from a configuration of a part described below at the engaging portion 110, the liquid ejecting device 1 according to the example has the same configuration as the liquid ejecting device 1 according to Example 1. Therefore, the liquid ejecting device 1 according to the example has the same features as those of the liquid ejecting device 1 according to Example 1 except for the part described below.

As illustrated in FIG. 10, in the engaging portion 110 of the liquid ejecting device 1 according to the example, with respect to the engaging portion 110 of the liquid ejecting device 1 according to Example 1, a configuration is adopted in which the lower receiving portion 111 provided at the main body side engaging portion 110A further includes a rail 111E including a plate-shaped portion 111F, and the upper receiving portion 112 provided at the liquid supply device side engaging portion 110B further includes a rail 112D extending in the +Z direction from the plate-shaped portion 112C. Then, the rail 111E and the plate-shaped portion 112C face each other in the vertical direction (Z-axis direction), the rail 112D and the plate-shaped portion 111F face each other in the vertical direction (Z-axis direction), and the rail 111E and the rail 112D face each other in the X-axis direction.

From another point of view, in the liquid ejecting device 1 according to the example, the upper receiving portion 112 includes inner rails (the upper rail 112B and the rail 112D) extending in the intersecting direction (Y-axis direction), and the lower receiving portion 111 includes outer rails (the lower rail 111B and the rail 111E) extending in the intersecting direction and covering the inner rails when viewed from the intersecting direction. Further, the upper rail 112B constituting the inner rail can be regarded as the upper receiving portion 112, and the lower rail 111B constituting the outer rail can be regarded as the lower receiving portion 111. With such a configuration, in the liquid ejecting device according to the example, the liquid supply device 100 can be positioned with respect to the main body 9 with high accuracy in both the vertical direction (Z-axis direction) and the facing direction (X-axis direction). Note that the outer rail covering the inner rail means that the outer rail does not necessarily need to cover the entire inner rail when viewed from the intersecting direction.

### Example 3

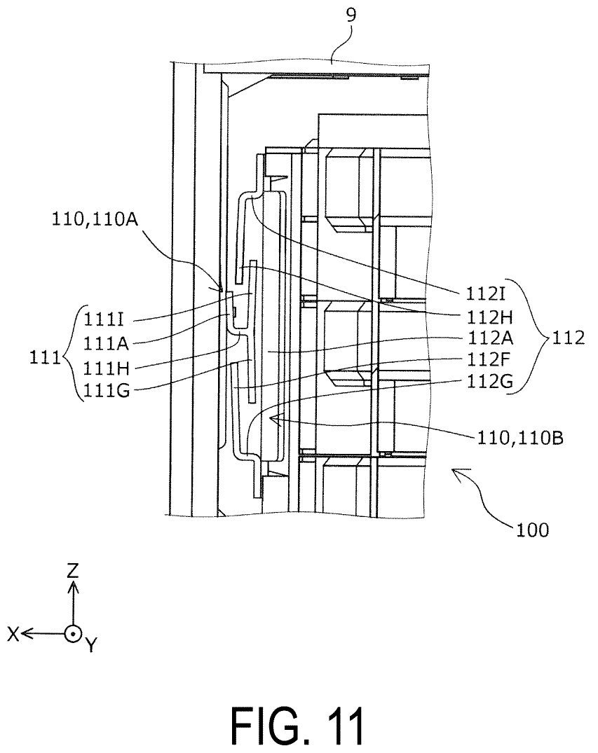

Next, the liquid ejecting device 1 according to Example 3 will be described using FIG. 11. Note that FIG. 11 is a diagram corresponding to FIG. 9 in the liquid ejecting device 1 according to Example 1. In FIG. 11, constituent members common to Example 1 and Example 2 described above are denoted with the same reference numerals, and detailed description thereof is omitted. Here, aside from a configuration of a part described below at the engaging portion 110, the liquid ejecting device 1 according to the example has the same configuration as the liquid ejecting device 1 according to Example 1 and Example 2. Therefore, the liquid ejecting device 1 according to the example has the same features as those of the liquid ejecting device 1 according to Example 1 and Example 2 except for the part described below.

As illustrated in FIG. 11, the engaging portion 110 of the liquid ejecting device 1 according to the example has the same configuration to that of the engaging portion 110 of the liquid ejecting device 1 according to Example 2 except that an inner rail and an outer rail are formed reversely. In detail, the engaging portion 110 of the liquid ejecting device 1 according to the example is provided with inner rails (a rail 111G and a rail 111I) at the main body side engaging portion 110A, and is provided with outer rails (a rail 112F and a rail 112H) at the liquid supply device side engaging portion 110B. Here, the rail 111G and the rail 111I are coupled to the main body attachment portion 111A by the plate-shaped portion 111H, the rail 112F is coupled to the liquid supply device attachment portion 112A by the plate-shaped portion 112G, and the rail 112H is coupled to the liquid supply device attachment portion 112A by the plate-shaped portion 1121.

Then, the rail 111G and the plate-shaped portion 112G face each other in the vertical direction (Z-axis direction), the rail 111I and the plate-shaped portion 1121 face each other in the vertical direction (Z-axis direction), and the rail 112F faces the plate-shaped portion 111H and the rail 112H faces the plate-shaped portion 111H in the vertical direction (Z-axis direction). Further, the rail 111G and the rail 112F face each other in the X-axis direction, and the rail 111I and the rail 112H face each other in the X-axis direction. Here, in the engaging portion 110 according to the example, the fact that the rail 111I receives the plate-shaped portion 1121 of the rail 112H from below corresponds to the fact that the main body side engaging portion 110A includes the lower receiving portion 111, and corresponds to the fact that the liquid supply device side engaging portion 110B includes the upper receiving portion 112.

From another point of view, in the liquid ejecting device according to the example, the lower receiving portion 111 includes the inner rails (the rail 111G and the rail 111I) extending in the intersecting direction (Y-axis direction), and the upper receiving portion 112 includes the outer rails (the rail 112F and the rail 112H) extending in the intersecting direction and covering the inner rails when viewed from the intersecting direction. Further, the rail 111I constituting the inner rail can be regarded as the lower receiving portion 111, and the rail 112H constituting the outer rail can be regarded as the upper receiving portion 112. With such a configuration, in the liquid ejecting device according to the example, it is possible to suppress unexpected disengagement of the main body side engaging portion 110A and the liquid supply device side engaging portion 110B in the engagement state, and to position the liquid supply device 100 with respect to the main body 9 in the facing direction (X-axis direction) with high accuracy.

The present disclosure is not limited to the example described above, and can be realized in various configurations without departing from the spirit of the present disclosure. Further, technical characteristics in the example corresponding to the technical characteristics in each form described in the SUMMARY can be substituted or combined appropriately to solve some or all of the above-described problems, or to achieve some or all of the above-described effects. Furthermore, when the technical characteristics are not described as being essential in the present specification, the technical characteristics can be deleted as appropriate.

What is claimed is:

1. A liquid ejecting device, comprising:
a liquid ejecting unit configured to eject liquid;
a main body on which the liquid ejecting unit is mounted;
a liquid supply device configured to be movable independently of the main body and configured to supply the liquid to the liquid ejecting unit via a liquid supply path;
a main body side engaging portion provided at the main body and configured to engage with the liquid supply device; and
a liquid supply device side engaging portion provided at the liquid supply device and configured to engage with the main body, wherein
the main body side engaging portion includes a lower receiving portion that receives the liquid supply device side engaging portion from below in a vertical direction, and
the liquid supply device side engaging portion includes an upper receiving portion that engages with the lower receiving portion, and is received by the main body side engaging portion from below in the vertical direction by the upper receiving portion engaging with and received by the lower receiving portion.

2. The liquid ejecting device according to claim 1, wherein
the upper receiving portion and the lower receiving portion extend in an intersecting direction intersecting both a facing direction in which the liquid supply device and the main body face each other in an engagement state in which the main body and the liquid supply device are engaged with each other, and the vertical direction.

3. The liquid ejecting device according to claim 2, wherein
one of the upper receiving portion and the lower receiving portion is an inner rail extending in the intersecting direction, and
another of the upper receiving portion and the lower receiving portion is an outer rail extending in the intersecting direction and covering the inner rail when viewed from the intersecting direction.

4. The liquid ejecting device according to claim 2, wherein
the upper receiving portion includes an upper rail received by the lower receiving portion from below in the vertical direction, and
the lower receiving portion includes a lower rail received by the upper receiving portion from above in the vertical direction.

5. The liquid ejecting device according to claim 2, wherein
the upper receiving portion and the lower receiving portion engage with each other by the main body and the liquid supply device being relatively moved along the intersecting direction.

6. The liquid ejecting device according to claim 2, wherein
the lower receiving portion includes an upward protruding portion extending in the intersecting direction and protruding upward in the vertical direction toward the upper receiving portion,
the upper receiving portion includes a downward protruding portion extending in the intersecting direction and protruding downward in the vertical direction toward the lower receiving portion, and
a length in the vertical direction from the upward protruding portion to the upper receiving portion and a length in the vertical direction from the downward protruding portion to the lower receiving portion are the same.

7. The liquid ejecting device according to claim 1, wherein
a coupling portion between the main body and the liquid supply device is configured to be brought into a usable state of being coupled by the liquid supply path in an engagement state in which the main body and the liquid supply device are engaged with each other, and
a relative movable range of the main body and the liquid supply device at the coupling portion is wider than a relative movable range of the main body side engaging portion and the liquid supply device side engaging portion in the usable state.

8. The liquid ejecting device according to claim 1, wherein
the main body side engaging portion and the liquid supply device side engaging portion have strength so as not to break even when the liquid supply device is brought into a state of being separated from an installation surface in an engagement state in which the main body and the liquid supply device are engaged with each other.
